(19) United States
(12) Patent Application Publication
(10) Pub. No.: US 2012/0289872 A1
(43) Pub. Date: Nov. 15, 2012

(54) BEAUTY MACHINE

(75) Inventor: Oscar CHOW, Zhongshan City (CN)

(73) Assignee: XIOTIN INDUSTRY CO., LTD., Zhongshan City (CN)

(21) Appl. No.: 13/188,279

(22) Filed: Jul. 21, 2011

(30) Foreign Application Priority Data
May 9, 2011 (CN) 201120144555.5

(51) Int. Cl. A61H 33/06

(52) U.S. Cl. 601/17

(57) ABSTRACT

A beauty machine includes a water pump, a steam generator connecting with an outlet of the water pump, and a container. The container includes a waste recycling storage area connecting with the steam generator, a cleaning liquid storage area and at least two cosmetic liquid storage areas. The cleaning liquid storage area and the cosmetic liquid storage areas connect with an inlet of the water pump. After the cosmetic liquid is forced by the water pump and vaporized quickly to steam by the steam generator, the water pump begins to draw the cleaning liquid to clean the residue in the pipeline, the water pump, the steam generator and so on, to thereby recycle the residual liquid into the waste recycling storage area. Discomfort and damage to the human body are not caused due to mixing the residue into the cosmetic liquid, and the quality of the cosmetic liquid can not be effected when using the beauty machine next time.

### BACKGROUND OF THE INVENTION

1. Technical Field

The present invention relates to daily necessities of human health, in particular, to improvement of a beauty machine structure.

2. Related Art

With the improvement of people's lives, people pay more attention to their skin than before. The traditional beauty machine includes a water pump used for pumping pressure, whose one end connects the vapour room for generating pressure, whose another end connects a magnet valve through a pipeline. The magnet valve connects with a cosmetic liquid container to control the entire pipeline. The beauty machine can simply and completely implement spraying, however, since cosmetic liquid contains, more or less, a certain chemical composition, the surface of the pipeline will retain residues of the steam formed by heating the cosmetic liquid. Considering the operating frequency of the beauty machine may be 3 or 5 days, the residual cosmetic liquid on the pipeline may get mildew and generate peculiar taste when the beauty machine is used in next time. Therefore, if the beauty machine is used again, the peculiar taste will be emitted and skin discomfort may be introduced, furthermore, skin allergy and damage may be caused.

### SUMMARY

The present invention aims to provide a beauty machine which has simple structure, easy operation, and recyclable waste therein to overcome defects of the existing techniques.

The present invention is solved by the following technical solutions: a beauty machine includes a water pump, a steam generator connecting with an outlet of the water pump and a container. The container includes a waste recycling storage area connected with the steam generator, a cleaning liquid storage area and at least two cosmetic liquid storage areas. The cleaning liquid storage area and the cosmetic liquid storage areas connect with an inlet of the water pump.

Further, the cleaning liquid storage area connects with the inlet of water pump through a first three-way magnet valve.

Further, the cosmetic liquid area connects with the first three-way magnet valve through a second three-way magnet valve.

Further, the waste recycling storage area connects with the steam generator through a two-way magnet valve.

Further, the container is produced integrally.

Further, the steam generator is installed in a vapour room whose an outlet connects with a steam nozzle, and a top of the steam nozzle is provided with a protective cover.

Further, the beauty machine also includes an internal pipeline which can automatically clean the internal pipeline and automatically recycle waste water.

The present invention has the following technical benefits:

The container of the present invention includes the waste recycling storage area connects with the steam generator, the cleaning liquid storage area and at least two cosmetic liquid storage areas. The cleaning liquid storage area and the cosmetic liquid storage areas connect with the inlet of the water pump. After the cosmetic liquid is forced by the water pump and vaporized quickly to steam by the steam generator, the water pump begins to draw the cleaning liquid to clean the residue in the pipeline, the water pump, the steam generator and so on, to thereby recycle the residual liquid into the waste recycling storage area. Discomfort and damage to the human body are not caused due to mixing the residue into the cosmetic liquid, and the quality of the cosmetic liquid can not be effected when using the beauty machine next time.

### BRIEF DESCRIPTION OF THE DRAWINGS

FIG. 1 illustrates a structure of an embodiment of the beauty machine in accordance with the present invention;

FIG. 2 illustrates a structure of an embodiment of a container in accordance with the present invention.

### DETAILED DESCRIPTION OF THE EMBODIMENTS

Objects, advantages and embodiments of the present invention will be explained below in detail with reference to the accompanying drawings. However, it is to be appreciated that the following description of the embodiment(s) is merely exemplary in nature and is no way intended to limit the invention, its application, or uses.

In accordance with heating principle, the embodiment of the present invention heats the cosmetic liquid into steam, and directly spouts the steam from the nozzle to a person in face, which makes skins can absorb the cosmetic liquid quickly to thereby rejuvenate the person in face.

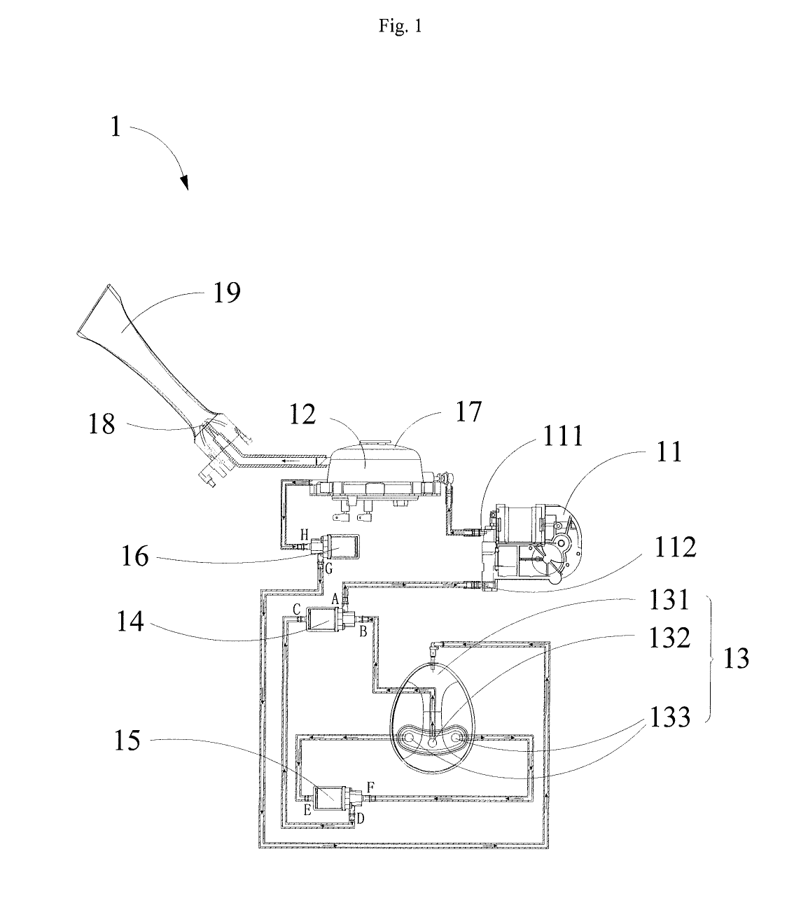

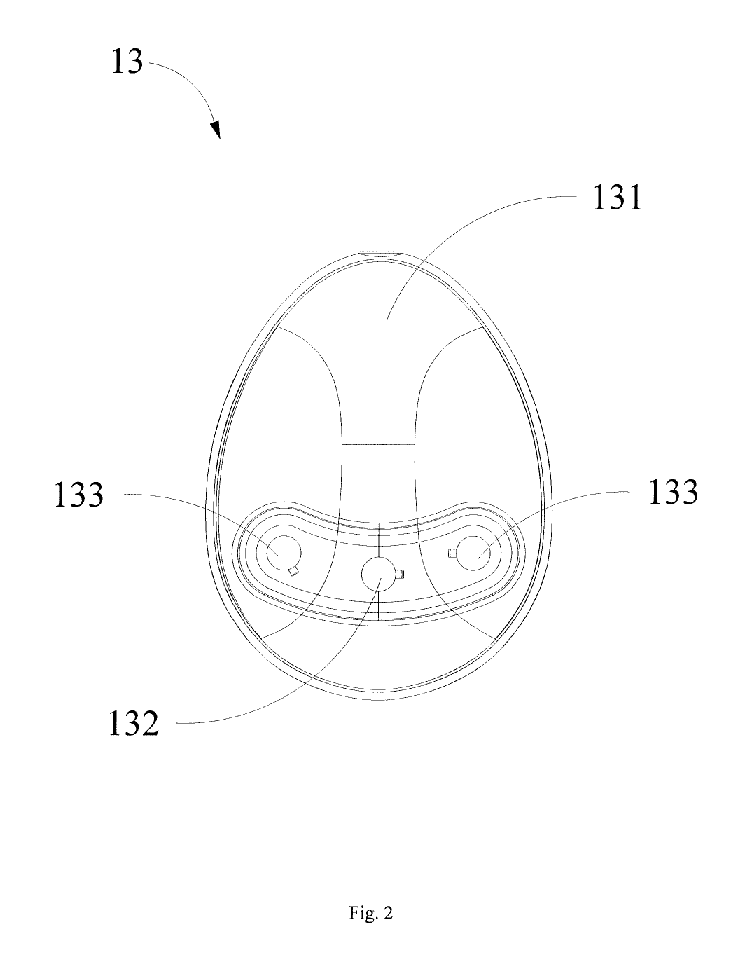

See FIGS. 1 and 2, a beauty machine is provided in accordance with the present invention. The beauty machine 1 includes a water pump 11, a steam generator 12 connecting with an outlet 111 of the water pump, and a container 13. The container 13 has a waste recycling storage area 131 connecting with the steam generator 12, a cleaning liquid storage area 132 and at least two cosmetic liquid storage areas 133 therein. The cleaning liquid storage area 132 and the cosmetic liquid storage areas 133 connect with an inlet 112 of the water pump. Therefore, the present invention provides the container 13 including the waste recycling storage area 131, the cleaning liquid storage area 132 and at least two cosmetic liquid storage areas 133 therein. The waste recycling storage area 131 connects with the steam generator 12. The cleaning liquid storage area 132 and the cosmetic liquid storage areas 133 connect with the inlet 112 of the water pump. After the cosmetic liquid is forced by the water pump 11 and vaporized quickly to steam by the steam generator 12, the water pump 11 begins to draw the cleaning liquid to clean the residue in the pipeline, the water pump 11, steam generator 12 and so on, to thereby recycle the residual liquid into the waste recycling storage area 131. Discomfort and damage to the human body are not caused due to mixing the residue into the cosmetic liquid, and the quality of the cosmetic liquid can not be effected when using the beauty machine next time.

Further, as shown in FIG. 1, in the embodiment of the present invention, the cleaning liquid storage area 132 connects with the inlet 112 of the water pump through a first three-way magnet valve 14. The inlet 112 of the water pump is connected with a joint A (labeled by a capital letter “A”) of the first three-way magnet valve 14 via a silica gel pipeline, and a joint B of the first three-way magnet valve 14 is connected with the cleaning liquid storage area 132 of the container 13 via another silica gel pipeline. Therefore, when the joint A and joint B of the first three-way magnet valve 14 are opened, the water pump 11 can draw the cleaning liquid quickly and directly. It should be noted that the water pump 11 is a pump for providing pumping pressure, and the cleaning liquid is common distilled water.

Further, as shown in FIG. 1, in the embodiment of the present invention, the cosmetic liquid storage area 133 are connected with the first three-way magnet valve 14 through a second three-way magnet valve 15, specifically, a joint D of the second three-way magnet valve 15 connects with a joint C of the first three-way magnet valve 14 via another silica gel pipeline. In this embodiment, there are two cosmetic liquid storage areas for storage of the cosmetic liquid, and the two cosmetic liquid storage areas locate at two sides of the cleaning liquid storage area 132 respectively, which makes silica gel pipelines easy to be arranged and the structure more compact. In other embodiments the cosmetic liquid storage area 133 can distribute one area or several areas. A joint E of the second three-way magnet valve 15 connects with one area of the cosmetic liquid storage area 133 through silica gel pipelines, and a joint F of the second three-way magnet valve 15 connects with the other area of the cosmetic liquid storage area 133 through silica gel pipelines, therefore, when the joint A and joint C of the first three-way magnet valve 14 and the joint D, joint E and joint F of the second three-way magnet valve 15 are opened, the water pump 11 can draw the cosmetic liquid quickly and directly.

Further, referring to FIG. 1, in this embodiment, the waste recycling storage area 131 connects the steam generator 12 through a two-way magnet valve 16. Specifically, a joint G of the two-way magnet valve 16 is connected with the waste recycling storage area 131 through another silica gel pipeline, and a joint H of the two-way magnet valve 16 is connected with the steam generator 12 through another silica gel pipeline. It is noticed that steam generator 12 is installed in the vapour room 17 to thereby ensure safety.

Further, referring to FIG. 2, in the structure of the embodiment of the present invention, the container 13 is produced integrally and is expendable. After a facial treatment is finished, the cosmetic liquid in the container 13 will be run out, so that is the container can be taken out and then be processed, which is very convenient and environmentally friendly.

See FIG. 1, the left cosmetic liquid is firstly sprayed, at this time the joint B of the first three-way magnet valve 14 is closed, and the joint A and joint C are opened; the joint F of the second three-way magnet valve 15 is closed and the joint D and joint E of the second three-way magnet valve 15 is opened. After the left cosmetic liquid is run out, the joint B of the first three-way magnet valve 14 is closed, and the joint A and joint C are opened; the joint E of the second three-way magnet valve 15 is closed and the joint D and joint F of the second three-way magnet valve 15 is opened, so that the right cosmetic liquid can be operated. The cosmetic liquid in vapour room 17 is vaporized quickly to high-temperature and high-pressure dry steam. An outlet of the vapour room 17 connects with a steam nozzle 18, so that a face and other positions of skin of a person can arm at the steam nozzle 18 via a protective cover to absorb steam. After the steam sprayed is finished, the joint C of the first three-way magnet valve 14 is closed, and the joints A, B of the first three-way magnet valve 14 is opened, at the same time, and the joints G, H of the two-way magnet valve 16 are opened, thus, the residue may be cleaned. While the cleaning work is finished, the cleaning waste liquid can be collected into the waste recycling storage area 131, it is no matter whether the three joints of the second three-way magnet valve are closed or opened.

The present invention may be embodied in other forms without departing from the spirit or novel characteristics thereof. The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

What is claimed is:

1. A beauty machine comprising:
a water pump and a steam generator connecting with an outlet of the water pump, and an expendable container; wherein the container comprises a waste recycling storage area, a cleaning liquid storage area and at least two cosmetic liquid storage areas, the waste recycling storage area connects with the steam generator, the cosmetic liquid storage areas and the cleaning liquid storage m area connect with an inlet of the water pump.

2. A beauty machine according to claim 1, wherein the cleaning liquid storage area connects with the inlet of the water pump through a first three-way magnet valve.

3. A beauty machine according to claim 2, wherein the cosmetic liquid storage area connects with the first three-way magnet valve through a second magnet valve.

4. A beauty machine according to claim 1, wherein the waste recycling storage area connects with the steam generator through a two-way magnet valve.

5. A beauty machine according to claim 1, wherein the container is manufactured integrally.

6. A beauty machine according to claim 1, wherein the steam generator is installed in a vapour room, an outlet of the vapour room connects with a steam nozzle, and a top of the steam nozzle is provided with a protective cover.

7. A beauty machine according to claim 1, wherein the beauty machine further comprises an internal pipeline which has the functions of automatically cleaning the internal pipeline and automatically recycling waste water.
